(19) United States
(12) Patent Application Publication
(10) Pub. No.: US 2014/0289082 A1
(43) Pub. Date: Sep. 25, 2014

(54) ELECTRIC CHARGING MANAGEMENT OF ELECTRIC VEHICLE

(71) Applicant: KT CORPORATION, Gyeonggi-do (KR)

(72) Inventors: Ho-Seok SEO, Daejeon (KR); Ki-Jung KIM, Gangwon-do (KR)

(73) Assignee: KT CORPORATION, Gyeonggi-do (KR)

(21) Appl. No.: 14/219,376

(22) Filed: Mar. 19, 2014

(30) Foreign Application Priority Data
Mar. 19, 2013 (KR) 10-2013-0029069

(51) Int. Cl. B60L 11/18; G06Q 30/04

(52) U.S. Cl. CPC B60L 11/1824; G06Q 30/04
USPC 705/34; 701/2

(57) ABSTRACT

Described embodiments relate to authorizing an electric vehicle to perform an electric charging operation. A server may receive an electric charging request message from user equipment associated with an electric vehicle, determine whether an electric vehicle is located near to an electric outlet within a predetermined distance based on information included in the electric charging request message in response to the electric charging request message, and transmit one of an electric charging approval message and an electric charging disapproval message to the electric vehicle based on the determination result.

### CROSS REFERENCE TO PRIOR APPLICATIONS

The present application claims priority under 35 U.S.C. §119 to Korean Patent Application No. 10-2013-0029069 (filed on Mar. 19, 2013), which is hereby incorporated by reference in its entirety.

### BACKGROUND OF THE INVENTION

The present disclosure relates to managing an electric charging operation of an electric vehicle and, more particularly, to controlling an electric charging operation of an electric vehicle for preventing unauthorized electricity use.

An electric vehicle uses electric power stored in a battery in the electric vehicle as a power source to run a motor for driving the electric vehicle. Such an electric vehicle was developed before an internal combustion engine vehicle. The electric vehicle has not been fully commercialized due to its practical problems, such as a heavy weight of the battery and a significant amount time required for charging a battery. Lately, an electric vehicle has been spotlighted since the electric vehicle produces less pollution and more environmental friendly as compared to an internal combustion engine vehicle.

In order to drive an electric vehicle, a battery of the electric vehicle has to be recharged. For recharging the battery, the electric vehicle is coupled to an electric outlet and provided with electric power from an associated electric power service provider. The electric vehicle may obtain such a service from an electric vehicle charging station which is a place specifically designed to charge the electric vehicle. Such an electric power service may be provided from any other place, such as home or office building, having an electric outlet for charging the electric vehicle. Thus, the electric vehicle can be charged at places that offer the electric outlet for charging.

### SUMMARY OF THE INVENTION

This summary is provided to introduce a selection of concepts in a simplified form that is further described below in the Detailed Description. This summary is not intended to identify key features or essential features of the claimed subject matter, nor is it intended to be used to limit the scope of the claimed subject matter.

Embodiments of the present invention overcome the above disadvantages and other disadvantages not described above. Also, the present invention is not required to overcome the disadvantages described above, and an embodiment of the present invention may not overcome any of the problems described above.

In accordance with an aspect of the present invention, an unauthorized electricity user for charging an electric vehicle may be prevented based on location information of an electric vehicle and location information of an electric outlet.

In accordance with another aspect of the present invention, an electric vehicle may be allowed to perform an electric charging operation based on location information of the electric vehicle and location information on an electric outlet.

In accordance with at least one embodiment, a method may be provided for authorizing an electric vehicle to perform an electric charging operation. The method of an electric charging authorizing server may include receiving an electric charging request message from user equipment associated with an electric vehicle, determining whether an electric vehicle is located near to an electric outlet within a predetermined distance based on information included in the electric charging request message in response to the electric charging request message, and transmitting one of an electric charging approval message and an electric charging disapproval message to the electric vehicle based on the determination result. The electric charging request message may include electric outlet identification information and user identification information, which are obtained from an identification code included in an electric outlet.

The electric outlet identification information may include location information of the electric outlet, service provider information, and electric power service information. The user identification information may include identification information of at least one of the user equipment and the electric vehicle and location information of at least one of the user equipment and the electric vehicle.

The electric charging request message may be generated by the user equipment. The user equipment may be configured to obtain electric outlet identification information from an identification code included in an electric outlet associated with the electric vehicle, to obtain user identification information including information on a user to be charged for an electric power service, and to generate the electric charging request message to include the obtained electric outlet identification information and the user identification information.

The user equipment may be configured to capture a code pattern image posted with the electric outlet and to obtain the electric outlet identification information by decoding the code pattern image. The user equipment may be configured to receiving the electric outlet identification information from a radio frequency identification (RFID) tag attached with the electric outlet through near field communication.

The determining may include extracting location information of the electric outlet and location information of at least one of the user equipment and the electric vehicle from the received electric charging request message, comparing the extracted location information of the electric outlet with the extracted location information of at least one of the user equipment and the electric vehicle, and generating one of the electric charging approval message and the electric charging disapproval message to the electric vehicle based on the comparison result.

The determining may include generating the electric charging approval message when the electric outlet is determined as being located near to at least one of the user equipment and the electric vehicle based on the comparison result. Otherwise, the determining may include generating the electric charging disapproval message. Then, the generated message may be transmitted to the electric vehicle.

The electric vehicle may be configured to receive at least one of the electric charging approval message and the electric charging disapproval message from the server, to control a battery to perform an electric charging operation for receiving electric power from the electric outlet in response to the electric charging approval message, and to control the battery not to perform the electric charging operation in response to the electric charging disapproval message.

The method may include receiving electric charging operation information from the electric vehicle upon generation of a predetermined event, obtaining associated electric outlet identification information and associated user identification information based on the received electric charging operation information, generating service fee information, and transmitting the generated service fee information to an associated accounting server.

The associated accounting server may be configured to calculate a service fee based on the service fee information from the server, to determine an actual user to be charged based on the service fee information, and to perform an operation for charging the determined actual user for the calculated service fee.

The electric charging operation information may include information on a charging date, a charging time, a charging amount, and an electric vehicle identification code.

The obtaining may include extracting electric vehicle identification information from the received electric charging operation information and obtaining the associated electric outlet identification information and the associated user identification information based on the extracted electric vehicle identification information.

The service fee information may include information on a charging date, a charging time, a charging amount, an actual user to be charged, an associated electric service provider, and an associated electric power service.

The method may further include transmitting electric outlet identification information and user identification information to an accounting server upon generation of a predetermined event. In this case, the accounting server may be configured to receive electric charging operation information from the electric vehicle upon generation of a predetermined event, to generate service fee information based on the received electric charging operation information, the received electric outlet identification information and the received user identification information, to calculate a service fee based on the generated service fee information, and perform an operation for charging the determined actual user for the calculated service fee.

In accordance with at least one embodiment, a method may be provided for authorizing an electric vehicle to perform an electric charging operation by user equipment. The method of the user equipment may include obtaining electric outlet identification information from an electric outlet upon generation of a predetermined event, obtaining user identification information of at least one of the user equipment and the electric vehicle, generating an electric charging request message based on the obtained information in order to perform an electric charging operation of the electric vehicle, and transmitting the generated electric charging request message to an electric charging authorization server.

In accordance with at least one embodiment, a method may be provided for authorizing an electric vehicle to perform an electric charging operation. The method of the electric vehicle may include receiving one of an electric charging approval message and an electric charging disapproval message from at least one of an electric charging authorization server and associated user equipment in response to an electric charging request message transmitted from the associated user equipment, controlling a power unit to perform an electric charging operation in response to the electric charging approval message, and controlling the power unit not to perform the electric charging operation in response to the electric charging approval message.

### BRIEF DESCRIPTION OF THE DRAWINGS

The above and/or other aspects of the present invention will become apparent and more readily appreciated from the following description of embodiments, taken in conjunction with the accompanying drawings, of which:

FIG. 1 illustrates an electric vehicle authentication system for authorizing an electric vehicle for electric charging in accordance with at least one embodiment;

FIG. 2 illustrates an electric vehicle and user equipment in accordance with at least one embodiment;

FIG. 3 illustrates an electric charging authorization server and an accounting server in accordance with at least one embodiment;

FIG. 4 illustrates a method for authorizing an electric vehicle for an electric charging operation in accordance with at least one embodiment;

FIG. 5 illustrates an operation for charging a person associated with an electric vehicle for an electric power service to charge an electric vehicle in accordance with at least one embodiment; and

FIG. 6 illustrates an operation for charging a person associated with an electric vehicle for an electric power service to charge an electric vehicle in accordance with another embodiment.

### DETAILED DESCRIPTION OF THE INVENTION

Reference will now be made in detail to embodiments of the present invention, examples of which are illustrated in the accompanying drawings, wherein like reference numerals refer to like elements throughout. The embodiments are described below, in order to explain the present invention by referring to the figures.

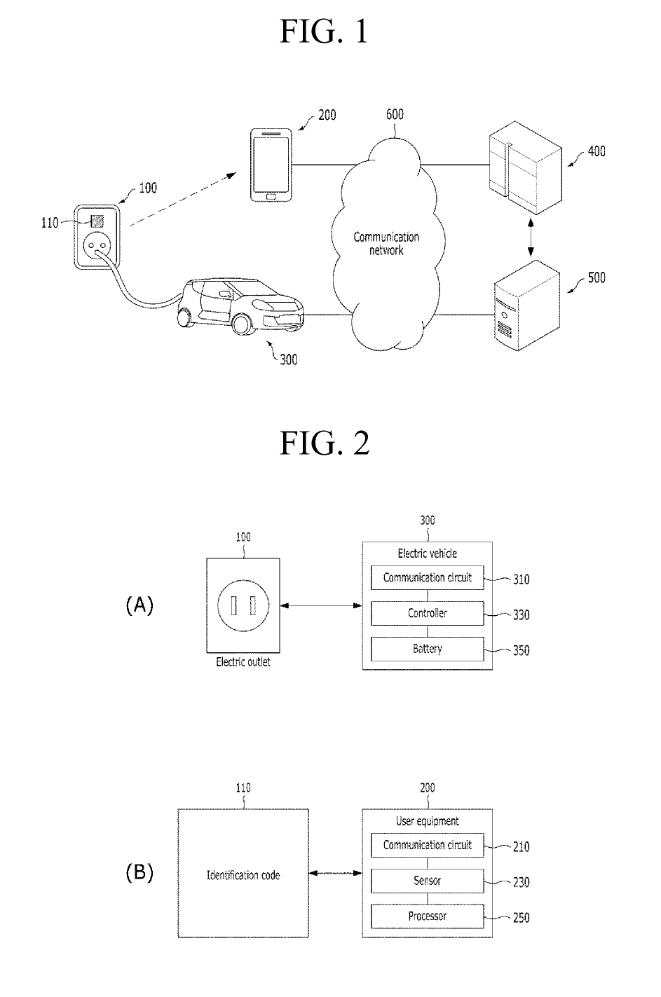

In accordance with at least one embodiment, an unauthorized electricity user of an electric vehicle may be prevented. Particularly, an electric vehicle may be allowed to perform an electric charging operation when a location of the electric vehicle is matched with a location of an electric outlet, which may be obtained from an identification code included in the electric outlet. Hereinafter, such an electric vehicle authentication system will be described with reference to FIG. 1.

FIG. 1 illustrates an electric vehicle authentication system for authorizing an electric vehicle for electric charging in accordance with at least one embodiment.

Referring to FIG. 1, electric vehicle charging system 10 may authorize an electric vehicle for electricity charging based on locations of electric vehicle 300 and electric outlet 100 in accordance with at least one embodiment. Such electric vehicle charging system 10 may include electric outlet 100, user equipment 200, electric vehicle 300, and electric charging authorization server 400. Such electric vehicle charging system 10 may prevent unauthorized use electricity for charging an electric vehicle.

For example, when an owner (e.g., a driver) of electric vehicle 300 wants to recharge a battery of electric vehicle 300, the owner may request electric charging authorization server 400 to authorize electric vehicle 300 for an electric charging operation through corresponding user equipment 200. That is, user equipment 200 may transmit an electric charging request message to electric charging authorization server 400 through communication network 600. User equipment 200 may transmit information on a location of electric outlet 100 and information on a location of electric vehicle 300 with the electric charging request message to electric charging authorization server 400. Such information on the location of electric outlet 100 may be obtained through various methods. For example, user equipment 200 may obtain the location information of electric outlet 100 from a code pattern image posted at electric output 100 or a radio frequency identification (RFID) chip attached with electric outlet 100 through near field communication.

In response to the electric charging request message, electric charging authorization server 400 may obtain location information of electric outlet 100 and location information of electric vehicle 300 and authorize electric vehicle 300 for the electric charging operation based on the obtained location information. That is, when the location information of electric outlet 100 is matched with the location information of electric vehicle 300, electric charging authorization server 400 may transmit an electric charging approval message to at least one of electric vehicle 300 and user equipment 200 through communication network 600. Otherwise, electric charging authorization server 400 may transmit an electric charging disapproval message to at least one of electric vehicle 300 and user equipment 200 through communication network 600.

At least one of electric vehicle 300 and user equipment 200 may receive one of the electric charging approval message and the electric charging disapproval message from electric charging authorization server 400 through communication network 600. In response to the electric charging approval message, electric vehicle 300 may be allowed to start the electric charging operation. Particularly, user equipment 200 may receive the electric charging approval message from electric charging authorization server 400 and control electric vehicle 300 to start the electric charging operation. Alternatively, electric vehicle 300 may directly receive the electric charging approval message from electric charging authorization server 400 and start the electric charging operation by controlling a battery thereof. In case of receiving the electric charging disapproval message, electric vehicle 300 may be prohibited from performing the electric charging operation from corresponding electric outlet 100.

In order to perform such an operation, user equipment 200 or electric vehicle 300 may be initiated to perform an electric charging authorization operation upon generation of a predetermined event. Such a predetermined event may include coupling of an electric cable between electric vehicle 300 and electric outlet 100 or entering a predetermined zone around electric outlet 100. A predetermined application installed in user equipment 200 or electric vehicle 300 may be executed upon the generation of the predetermined event and produce and display a graphic user interface for inquiring a driver to enter location information of electric outlet and electric vehicle 300. When the driver inputs the requested location information, user equipment 200 or electric vehicle 300 may transmit the electric charging request message to electric charging authorization server 400 through communication network 600. The present invention, however, is not limited thereto. User equipment 200 or electric vehicle 300 may automatically obtain location information on electric outlet 100 and transmit the electric charging request message when electric vehicle 300 is coupled to electric output 100 through a physical cable.

Electric vehicle charging system 10 may further include accounting server 500. Accounting server 500 may receive information (e.g., service fee information) on an amount of electricity supplied to electric vehicle 300 and perform an associated accounting process for charging an actual user associated with electric vehicle 300 for the electric power service. Although accounting server 500 is illustrated as an independent server from electric charging authorization server 400, the present invention is not limited thereto. Such accounting server 500 may be implemented with electric charging authorization server 400 as one computing server.

As described, at least one of electric vehicle 300 and user equipment 200 may transmit an electric charging request message to electric charging authorization server 400 through communication network 600 and receive one of an electric charging approval message and an electric charging disapproval message from electric charging authorization server 400 through communication network 600. In response to the electric charging approval message, electric vehicle 300 may be allowed to perform the electric charging operation. Such operation of user equipment 200 and electric vehicle 300 will be described in detail with reference to FIG. 2.

FIG. 2 illustrates an electric vehicle and user equipment in accordance with at least one embodiment. Particularly, a diagram (A) of FIG. 2 illustrates electric vehicle 300 and a diagram (B) of FIG. 2 illustrates user equipment 200.

As shown in the diagram (A), electric vehicle 300 may include communication circuit 310, controller 330, and battery 350.

Communication circuit 310 may establish a communication link to at least one of user terminal 200, electric charging authorization server 410, and accounting server 500. Through the established link, communication circuit 300 may receive information from or transmit information to at least one of user terminal 200, electric charging authorization server 400, and accounting server 500. For example, communication circuit 310 may perform communication based on Digital Subscriber Line (xDSL), Hybrid Fiber Coaxial (HFC), Power Line Communication (PLC), satellites, GSM EDGE Radio Access Network (GERAN), UMTS Terrestrial Radio Access Network (UTRAN), evolved UMTS Terrestrial Radio Access Network (eUTRAN), Wireless Local Area Network (WLAN), and Worldwide Interoperability for Microwave Access (WiMAX), or a mobile communication network based on CDMA/WCDMA or GSM/GPRS.

In accordance with at least one embodiment, communication circuit 310 may receive an electric charging approval message or an electric charging disapproval message from electric charging authorization server 400 through communication network 600. The present invention is not limited thereto. Such an electric charging approval message may be received through user equipment 200. Furthermore, communication circuit 310 may transmit charging operation information to electric charging authorization server 400. Such charging operation information may include information a charging date, a charging time, a charging amount, and a vehicle identification code.

Controller 330 may control overall operation of the constituent elements of electric vehicle 300. Controller 330 may control battery 350 to perform an electric charging operation in response to the electric charging approval message. For example, although electric vehicle 300 is coupled to electric outlet 100 through a physical cable, controller 300 may control battery 350 not to start an electric charging operation until the electric charging approval message is received through communication circuit 310. Controller 330 may prohibit battery 350 from performing the electric charging operation in response to the electric charging disapproval message. For example, controller 330 may control a switch associated with battery 350 to perform the electric charging operation based on the electric charging approval message and the electric charging disapproval message.

Controller 330 may be a battery management system (BMS) of electric vehicle 300 for controlling the electric charging operation of battery 350. Communication circuit 310 may be a telemetric device mounted on electric vehicle 300. For example, communication circuit 310 may be a navigation device mounted on electric vehicle 300.

Controller 300 may generate charging operation information to include information a charging date, a charging time, a charging amount, and a vehicle identification code. Controller 300 may transmit the generated charging operation information to at least one of electric charging authorization server 400 and accounting server 500 through communication circuit 310.

As shown in the diagram (B), electric outlet 100 may include identification code 110. Such identification code 110 may include information on a location of electric outlet 100, information on an associated electric power service provider (e.g., identification information of a service provider), and information on an electric power service (e.g., an electric service rate, a person to charge for an electric power service, and so forth.).

Identification code 110 may be a code pattern image including a bar code and a quick response (QR) code. Furthermore, identification code 110 may be included in a radio frequency identification (RFID) chip or a RFID tag, which may be attached at electric outlet 100.

User equipment 200 may be an electric mobile device capable of wireless communication and sensing identification code 110 of electric outlet 100. For example, user equipment 200 may be a smart phone, a pad-like device, and a tablet personal computer (PC), which is owned by a driver or an owner of electric vehicle 300. Furthermore, user equipment 200 may be a device mounted on electric vehicle 300, which is capable sensing identification code 110 of electric outlet 100. In this case, user equipment 200 may be a navigation device or an entertainment system mounted on electric vehicle 300.

As shown in the diagram (B), user equipment 200 may include communication circuit 210, sensor 230, and processor 250.

Communication circuit 210 may establish a communication link to at least one of electric vehicle 300, electric charging authorization server 410, and accounting server 500. Through the established link, communication circuit 210 may receive information from or transmit information to at least one of electric vehicle 300, electric charging authorization server 400, and accounting server 500. For example, communication circuit 310 may perform communication based on Digital Subscriber Line (xDSL), Hybrid Fiber Coaxial (HFC), Power Line Communication (PLC), satellites, GSM EDGE Radio Access Network (GERAN), UMTS Terrestrial Radio Access Network (UTRAN), evolved UMTS Terrestrial Radio Access Network (eUTRAN), Wireless Local Area Network (WLAN), and Worldwide Interoperability for Microwave Access (WiMAX), or a mobile communication network based on CDMA/WCDMA or GSM/GPRS.

Sensor 230 may obtain identification code 110 of electric outlet 100. For example, sensor 230 may capture a code pattern image (e.g., QR code or bar code) of identification code 110. In this case, sensor 230 may be a camera device included in user equipment 200. Furthermore, sensor 230 may obtain identification cod 110 of electric outlet 100 through near field communication. In this case, identification code 110 may be included in a RFID tag attached at electric outlet 100 and sensor 230 may be a RFID device included in user equipment 200.

Processor 250 may control overall operation of the constituent elements of user equipment 200. Processor 250 may generate an electric charging request message to included information on the obtained identification code 110. For example, processor 250 may decode the code pattern image (e.g., QR code or bar code) captured through sensor 230 and obtain information on electric outlet 100. Such obtained information may include information on a location of electric outlet 100, information on an associated electric power service provider (e.g., identification information of a service provider), and information on an electric power service (e.g., an electric service rate, a person to charge for an electric power service, and so forth.). Furthermore, processor 250 may include information on electric vehicle 300 (e.g., electric vehicle information) or information on user equipment 200 (e.g., user equipment information) in the generated electric charging request message, such as location information on user equipment 200 or electric vehicle 300, identification information of user equipment 200, and identification information of electric vehicle 300.

Communication circuit 210 may transmit the generated electric charging request message to electric charging authorization server 400 through communication network 600. Furthermore, communication circuit 210 may receive one of an electric charging approval message and an electric charging disapproval message from electric charging authorization server 400 and deliver the received message to electric vehicle 300.

In order to perform such an operation, user equipment 200 may be installed with and execute an application for an electric charging authorization service. Such an application may be executed upon generation of a predetermined event and produce a graphic user interface for entering location information of electric outlet 100, for capturing identification code 110 of electric outlet 100, and for transmitting the obtained information to at least one of electric vehicle 300 and electric charging authorization server 400.

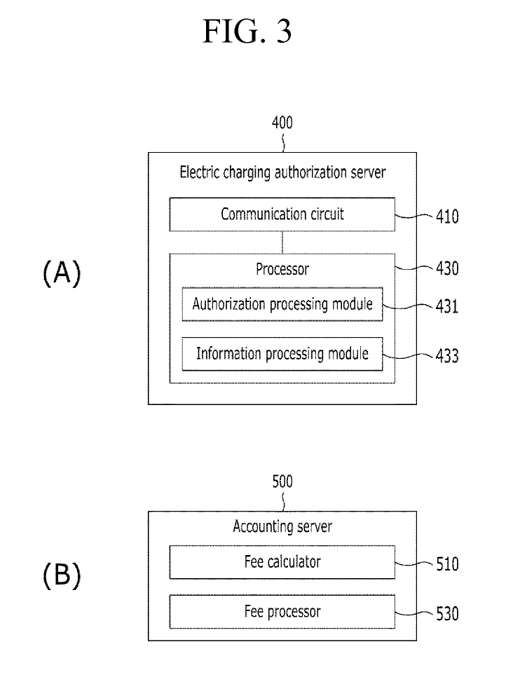

As described, electric charging authorization server 400 may authorize electric vehicle 300 for an electric charging operation based on a location of electric vehicle 300 and a location of electric outlet 100. After perform the electric charging operation, accounting server 500 may perform an operation for charging an actual user of the electric charging operation for an associated service fee. Such electric charging authorization server 400 and accounting server 500 will be described with reference to FIG. 3.

FIG. 3 illustrates an electric charging authorization server and an accounting server in accordance with at least one embodiment. Particularly, a diagram (A) of FIG. 3 illustrates electric charging authorization server 400 and a diagram (B) of FIG. 3 illustrates accounting server 500.

Referring to FIG. 3, electric charging authorization server 400 receives an electric charging request message transmitted from user equipment 200, extracts location information of electric outlet 150 from the charging request message, compares the extracted location information of electric outlet 150 with location information of user equipment 200, and authorizes electric vehicle 300 to start charging operation when the extracted location information of electric outlet 150 is matched with the location information of user equipment. In order to perform such operation, electric charging authorization server 40 may include communication circuit 410 and processor 430. Processor 430 may further include authorization processing module 431 and information processor 433.

Communication circuit 410 may establish a communication link to at least one of user equipment 200, electric vehicle 300, and accounting server 500. Through the established link, communication circuit 40 may receive information from or transmit information to at least one of user equipment 200, electric vehicle 300, and accounting server 500. For example, communication circuit 310 may perform communication based on Digital Subscriber Line (xDSL), Hybrid Fiber Coaxial (HFC), Power Line Communication (PLC), satellites, GSM EDGE Radio Access Network (GERAN), UMTS Terrestrial Radio Access Network (UTRAN), evolved UMTS Terrestrial Radio Access Network (eUTRAN), Wireless Local Area Network (WLAN), and Worldwide Interoperability for Microwave Access (WiMAX), or a mobile communication network based on CDMA/WCDMA or GSM/GPRS.

Communication circuit 410 may receive an electric charging request message from user equipment 200 and electric charging operation information from electric vehicle 300. Furthermore, communication circuit 410 may provide identification information of electric outlet 100 (e.g., electric outlet identification information), identification information of a user for the electric power service (e.g., user identification information), and information on an electric power service fee (e.g., service fee information) to accounting server 500.

Authorization processing module 431 may compare location information of electric outlet 100 with location information of user equipment 200 (e.g., or electric vehicle 300) and generate one of an electric charging approval message and an electric charging disapproval message based on the comparison result. That is, when the location information of electric outlet 100 is matched with the location information of user equipment 200 or electric vehicle 300, authorization processing module 431 generates the electric charging approval message. Otherwise, authorization processing module 431 generates the electric charging disapproval message. When the location information of electric outlet 100 is matched with the location information of user equipment 200, electric vehicle 300 may be located near to electric outlet 100 within a predetermined distance.

Information processor 433 may generate service fee information based on the electric charging operation information, the electric outlet identification information, and user identification information. The electric charging operation information may be obtained from electric vehicle 300. Based on the electric charging operation information, electric charging authorization server 400 may obtain the electric outlet identification information and the user identification information from the electric charging request message received from user equipment 200.

Accounting server 500 may perform an operation for charging an actual user of an electric power service for charging electric vehicle 300 based on the service fee information received from electric charging authorization server 400. The present invention, however, is not limited thereto. Accounting server 500 may receive the electric charging operation information directly from electric vehicle 300 and the electric outlet identification information and the user identification information directly from electric charging authorization server 400 to perform the operation for charging an actual user of the electric power service for charging electric vehicle 300. Based on the received information, accounting server 500 may calculate a service fee and charge an actual user for the electric service fee. Accounting server 500 may cooperate with a financial system or an accounting system of an electric service provider.

In order to perform such an operation, accounting server 500 may include service fee calculator 510 and service fee processor 530, as shown in the diagram (B) of FIG. 3. Service fee calculator 510 may calculate an electric power service fee based on the service fee information from electric vehicle 300. Service fee processor 530 may perform an operation for charging the actual user for the calculated electric power service fee based on the electric outlet identification information and the user identification information. That is, service fee processor 530 may determine the actual user based on the electric outlet identification information and the user identification information and charge the determined user for the calculated electric power service fee.

Accounting server 500 and electric charging authorization server 400 may be implemented as one computing server. That is, electric charging authorization server 400 may be a computing system for a service provider for preventing unauthorized user of an electric power service. Electric charging authorization server 400 may be included in a server of the electric service provider with accounting server 500. Furthermore, accounting server 500 may be a computing system for a bank or a financial institute for charging an electric service fee. Accounting server 500 and electric charging authorization server 400 may communicate with each other through communication network 600.

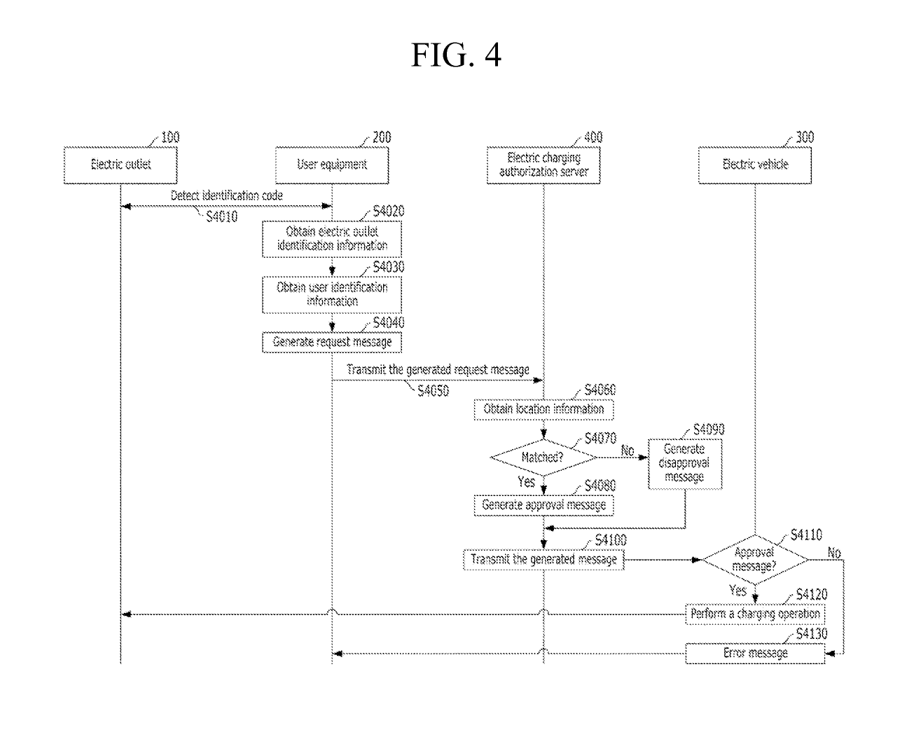

As described, electric vehicle 300 may be authorized to perform an electric charging operation based on a location of electric vehicle 300 and a location of electric outlet 100. Such operation will be described with reference to FIG. 4.

FIG. 4 illustrates a method for authorizing an electric vehicle for an electric charging operation in accordance with at least one embodiment.

At step S4010, an identification code of an electric outlet may be detected. For example, user equipment 200 may be inquired to detect identification code 110 of electric outlet 100 upon generation of a predetermined event. Such a predetermined event may include connecting of a physical cable between electric vehicle 300 and electric outlet 100, scanning of a code pattern image of electric outlet 100, or receiving a NFC signal from a RFID tag of electric outlet 100. Upon the generation of such events, a predetermined application installed in user equipment 200 may be initiated and produce and display a graphic user interface for inquiring an associated user (e.g., a driver) of electric vehicle 300 to enter or to detect identification information of electric outlet 100.

In response to such inquiry, user equipment 200 may detect identification code 110 of electric outlet 100. Such detection of identification code 110 may be performed through various methods. When identification code 110 is a code pattern image (e.g., QR code or bar code), user equipment 200 captures a code pattern image of electric outlet 100 using a camera device included in user equipment 200. When identification code 110 is included in a RFID tag, user equipment 200 may obtain identification code 110 from an associated RFID tag attached at electric outlet 100 through near field communication.

At step S4020, electric outlet identification information may be obtained. For example, user equipment 200 may obtain electric outlet identification information from the obtained identification code 110. Particularly, user equipment 200 may decode the captured code pattern image and extract the electric outlet identification information. Such electric outlet identification information may include information on a location of electric outlet 100 (e.g., location information), information on an associated electric power service provider (e.g., identification information of a service provider), and information on an electric power service (e.g., an electric service rate and a person to charge for an electric power service).

At step S4030, user identification information may be obtained. For example, user equipment 200 may obtain user identification information. The user identification information may be information on an actual user for the electric power service for charging electric vehicle 300. That is, user identification information may be information on an actual user to be charged for the electric power service. The user identification information may include identification information of at least one of user equipment 200 and electric vehicle 300 and location information of at least one of user equipment 200 and electric vehicle 300.

At step S4040, an electric charging request message may be generated. For example, user equipment 200 may generate the electric charging request message to include the obtained electric outlet identification information and the user identification information.

At step S4050, the electric charging request message may be transmitted. For example, user equipment 200 may request electric charging authorization server 400 to authorize electric vehicle 300 for an electric charging operation and transmit the generated electric charging request message to electric charging authorization server 400 through communication network 600.

At step S4060, location information may be obtained. For example, in response to the electric charging request message, electric charging authorization server 400 extract the location information of electric outlet 100 and the location information of at least one of user equipment 200 and electric vehicle 300 from the received electric charging request message.

At step S4070, determination may be made so as whether the location information of electric outlet 100 is matched with the location information of at least one of user equipment 200 and electric vehicle 300. For example, electric charging authorization server 400 may determine whether electric outlet 100 is located near to at least one of user equipment 200 and electric vehicle 300 based on the obtained location information thereof. When electric vehicle 300 is located near to electric outlet 100 within a predetermined distance, electric charging authorization server 400 authorizes electric vehicle 300 to perform an electric charging operation. When electric vehicle 300 is separated from electric outlet 100 farther than the predetermined distance, electric charging authorization server 400 determines the charging operation request from user equipment 200 is suspicious or an abnormal charging operation.

When electric charging authorization server 400 determines the electric outlet 100 is located near to at least one of user equipment 200 and electric vehicle 300 (Yes—S4070), an electric charging approval message may be generated at step S4080. For example, when electric charging authorization server 400 determines that the electric charging operation request from user equipment 200 is a normal electric charging operation based on the location information of electric outlet 100 and at least one of user equipment 200 and electric vehicle 300, charging authorization server 400 generates the electric charging approval message at step S4080.

When electric charging authorization server 400 determines the requested electric charging operation is suspicious (No—S4070), an electric charging disapproval message may be generated at step S4090. For example, when electric vehicle 300 is separated from electric outlet 100 farther than the predetermined distance, electric charging authorization server 400 determines the charging operation request from user equipment 200 is suspicious or an abnormal charging operation. In this case, electric charging authorization server 400 generates the electric charging disapproval message.

At step S4100, the generated message may be transmitted. For example, electric charging authorization server 400 transmits one of the electric charging approval message and the electric charging disapproval message to electric vehicle 300. Alternatively, electric charging authorization server 400 may transmit the generated message to user equipment 200. In this case, user equipment 200 may receive the generated message and control electric vehicle 300 based on the generated message. Or, user equipment may deliver the received message to electric vehicle 300.

At step S4110, determination may be made so as whether the received message is the electric charging approval message or the electric charging disapproval message. For example, electric vehicle 300 receives the message and determines whether the received message is the electric charging approval message or the electric charging disapproval message.

When the received message is the electric charging approval message (Yes—S4110), a charging operation may be started at step S4120. For example, when the received message is the electric charging approval message, electric vehicle 300 starts the electric charging operation. Particularly, electric vehicle 300 may establish a path to electric outlet 100 by turning on a predetermined switch associated with battery 350 and start receiving electric power from electric outlet 100.

When the received message is the electric charging disapproval message (No—S4110), an error message may be transmitted at step S4130. For example, when the received message is the electric charging disapproval message, electric vehicle 300 may display an error message through a predetermined device (e.g., a display mounted on electric vehicle 300) or user equipment 200. That is, electric vehicle 300 may turn off a predetermined switch associated with battery 350 in order to block a path to electric outlet 100.

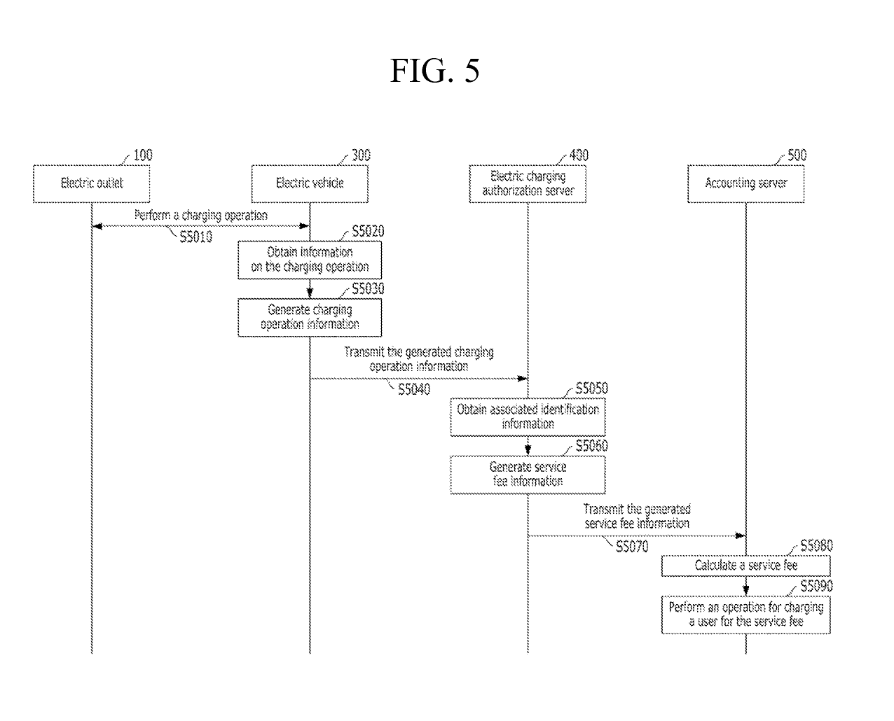

FIG. 5 illustrates an operation for charging a person associated with an electric vehicle for an electric power service to charge an electric vehicle in accordance with at least one embodiment.

At step S5010, an electric charging operation may be performed. For example, after electric vehicle 300 receives the electric charging approval message from electric charging authorization server 400, electric vehicle 300 starts the electric charging operation for receiving electricity from electric outlet 100.

At step S5020, information on a status of the electric charging operation may be obtained upon the end of the electric charging operation. For example, electric vehicle 300 may continuously monitor the electric charging operation. That is, electric vehicle 300 may continuously obtain status of the electric charging operation. Particularly, electric vehicle 300 may detect completion of the electric charging operation or interruption of the electric charging operation while monitoring the status of the electric charging operation.

At step S5030, the charging operation information may be generated. For example, when completely charging electric vehicle 300 or when the electric charging operation is interrupted, electric vehicle 300 may collect information on a charging date, a charging time, a charging amount, and electric vehicle identification. Based on the collected information, electric vehicle 300 generates the charging operation information.

At step S5040, the generated charging operation information may be transmitted. For example, electric vehicle 300 transmits the generated charging operation information to electric charging authorization server 400 through communication network 600. The present invention, however, is not limited thereto. Electric vehicle 300 may transmit the generated charging operation information to user equipment 200 and user equipment 200 may deliver the generated charging operation information to electric charging authorization server 400.

At step S5050, associated identification information may be obtained. For example, electric charging authorization server 400 may obtain electric outlet identification information and user identification information based on the obtained charging operation information. That is, electric charging authorization server 400 may extract electric vehicle identification information from the obtained charging operation information and obtain associated electric outlet identification information and the associated user identification information based on the extracted electric vehicle identification information. Such associated electric outlet identification information and the associated user identification information may be obtained from the electric charging request message from user equipment 200.

At step S5060, service fee information may be generated. For example, electric charging authorization server 400 may generate service fee information based on the obtained information, such as the charging operation information, the associated electric outlet identification information, and the associated user identification information. The service fee information may include information on a charging date, a charging time, an charging amount, an actual user to be charged (e.g., included in the user identification information), an electric service provider (e.g., included in the electric outlet identification information), and so forth. That is, the service fee information may include information on a user to be charged and a service provider who charges the user.

At step S5070, the generated service fee information may be transmitted. For example, electric charging authorization server 400 may transmit the generated service fee information to accounting server 500 through communication network 600.

At step S5080, a service fee may be calculated. For example, upon the receipt of the generated service fee information, accounting server 500 may calculate a service fee based on the received service fee information (e.g., information on a charging date, a charging time, and a charging amount).

At step S5090, an operation may be performed for charging a user for the service fee. For example, accounting server 500 may perform an operation for charging the actual user for the electric charging server based on the calculated service fee.

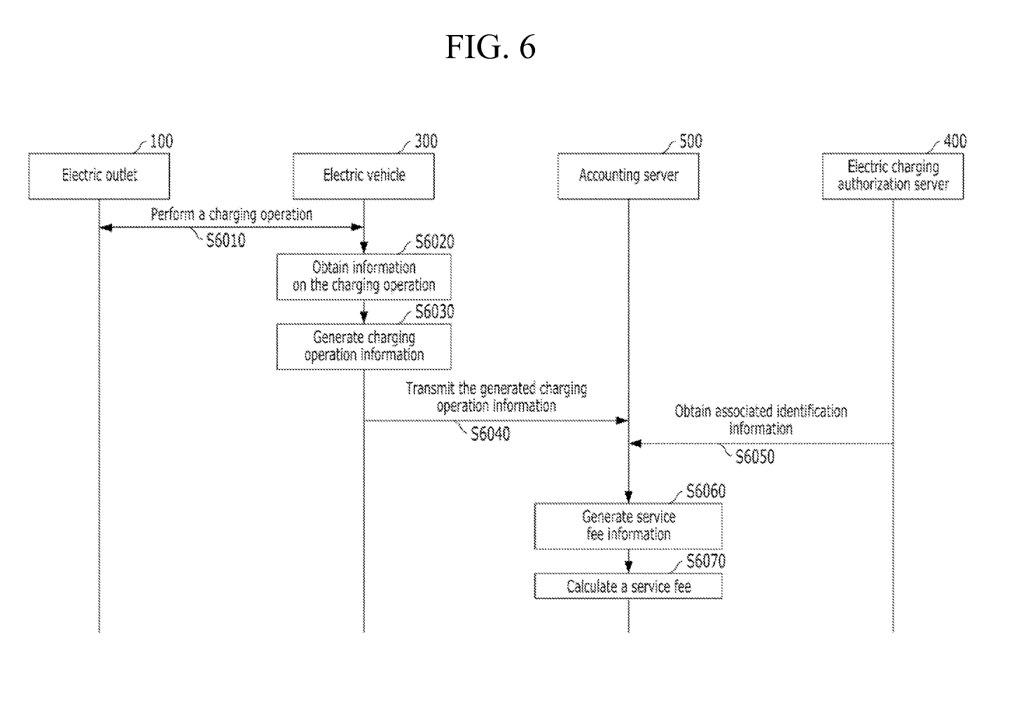

FIG. 6 illustrates an operation for charging a person associated with an electric vehicle for an electric power service to charge an electric vehicle in accordance with another embodiment.

At step S6010, an electric charging operation may be performed. For example, after electric vehicle 300 receives the electric charging approval message from electric charging authorization server 400, electric vehicle 300 starts the electric charging operation for receiving electricity from electric outlet 100.

At step S6020, information on a status of the electric charging operation may be obtained upon the end of the electric charging operation. For example, electric vehicle 300 may continuously monitor the electric charging operation. That is, electric vehicle 300 may continuously obtain status of the electric charging operation. Particularly, electric vehicle 300 may detect completion of the electric charging operation or interruption of the electric charging operation while monitoring the status of the electric charging operation.

At step S6030, the charging operation information may be generated. For example, when completely charging electric vehicle 300 or when the electric charging operation is interrupted, electric vehicle 300 may collect information on a charging date, a charging time, a charging amount, and electric vehicle identification. Based on the collected information, electric vehicle 300 generates the charging operation information.

At step S6040, the generated charging operation information may be transmitted. For example, electric vehicle 300 transmits the generated charging operation information to accounting server 500 through communication network 600. The present invention, however, is not limited thereto. Electric vehicle 300 may transmit the generated charging operation information to user equipment 200 and user equipment 200 may deliver the generated charging operation information to accounting server 500.

At step S6050, associated identification information may be obtained. For example, accounting server 500 may obtain electric outlet identification information and user identification information from electric charging authorization server 400 based on the obtained charging operation information. That is, accounting server 500 may extract electric vehicle identification information from the obtained charging operation information and request electric charging authorization server 400 to provide associated electric outlet identification information and associated user identification information by transmitting the extracted electric vehicle identification information. In response to such request, electric charging authorization server 400 may obtain such associated electric outlet identification information and the associated user identification information from the electric charging request message from user equipment 200 based on the electric vehicle identification information and provides the associated electric outlet identification information and the associated user identification information to accounting server 500.

At step S6060, service fee information may be generated. For example, accounting server 500 may generate service fee information based on the obtained information, such as the charging operation information, the associated electric outlet identification information, and the associated user identification information. The service fee information may include information on a charging date, a charging time, an charging amount, an actual user to be charged (e.g., included in the user identification information), an electric service provider (e.g., included in the electric outlet identification information), and so forth. That is, the service fee information may include information on a user to be charged and a service provider who charges the user.

At step S6070, a service fee may be calculated. For example, based on the generated service fee information, accounting server 500 may calculate a service fee based on the received service fee information (e.g., information on a charging date, a charging time, and a charging amount).

At step S6080, an operation may be performed for charging a user for the service fee. For example, accounting server 500 may perform an operation for charging the actual user for the electric charging server based on the calculated service fee.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The present invention can be embodied in the form of methods and apparatuses for practicing those methods. The present invention can also be embodied in the form of program code embodied in tangible media, non-transitory media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

No claim element herein is to be construed under the provisions of 35 U.S.C. §112, sixth paragraph, unless the element is expressly recited using the phrase “means for” or “step for.”

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of authorizing an electric vehicle to perform an electric charging operation by a server, the method comprising:
receiving an electric charging request message from user equipment associated with an electric vehicle;
determining whether an electric vehicle is located near to an electric outlet within a predetermined distance based on information included in the electric charging request message in response to the electric charging request message; and
transmitting one of an electric charging approval message and an electric charging disapproval message to the electric vehicle based on the determination result.

2. The method of claim 1, wherein the electric charging request message includes electric outlet identification information and user identification information, which are obtained from an identification code included in an electric outlet.

3. The method of claim 2, wherein:
the electric outlet identification information includes location information of the electric outlet, service provider information, and electric power service information; and
the user identification information includes identification information of at least one of the user equipment and the electric vehicle and location information of at least one of the user equipment and the electric vehicle.

4. The method of claim 1, wherein:
the electric charging request message is generated by the user equipment;
the user equipment is configured to:
obtain electric outlet identification information from an identification code included in an electric outlet associated with the electric vehicle;
obtain user identification information including information on a user to be charged for an electric power service; and
generating the electric charging request message to include the obtained electric outlet identification information and the user identification information.

5. The method of claim 4, wherein the user equipment is configured to:
scan a code pattern image posted with the electric outlet; and
obtain the electric outlet identification information by decoding the code pattern image.

6. The method of claim 4, wherein the user equipment is configured to:
receiving the electric outlet identification information from a radio frequency identification (RFID) tag attached with the electric outlet through near field communication.

7. The method of claim 1, wherein the determining includes:
extracting location information of the electric outlet and location information of at least one of the user equipment and the electric vehicle from the received electric charging request message;
comparing the extracted location information of the electric outlet with the extracted location information of at least one of the user equipment and the electric vehicle; and
generating one of the electric charging approval message and the electric charging disapproval message to the electric vehicle based on the comparison result.

8. The method of claim 7, wherein the determining includes:
generating the electric charging approval message when the electric outlet is determined as being located near to at least one of the user equipment and the electric vehicle based on the comparison result;
otherwise, generating the electric charging disapproval message; and
transmitting the generated message to the electric vehicle.

9. The method of claim 1, wherein the electric vehicle is configured to:
receive at least one of the electric charging approval message and the electric charging disapproval message from the server;
control a battery to perform an electric charging operation for receiving electric power from the electric outlet in response to the electric charging approval message; and
control the battery not to perform the electric charging operation in response to the electric charging disapproval message.

10. The method of claim 1, comprising:
receiving electric charging operation information from the electric vehicle upon generation of a predetermined event;
obtaining associated electric outlet identification information and associated user identification information based on the received electric charging operation information;
generating service fee information; and
transmitting the generated service fee information to an associated accounting server.

11. The method of claim 10, wherein the associated accounting server is configured to:
calculate a service fee based on the service fee information from the server;
determine an actual user to be charged based on the service fee information; and
perform an operation for charging the determined actual user for the calculated service fee.

12. The method of claim 10, wherein the electric charging operation information on a charging date, a charging time, a charging amount, and an electric vehicle identification code.

13. The method of claim 10, wherein the obtaining includes:
extracting an electric vehicle identification information from the received electric charging operation information; and
obtaining the associated electric outlet identification information and the associated user identification information based on the extracted electric vehicle identification information.

14. The method of claim 10, wherein the service fee information includes information on a charging date, a charging time, a charging amount, an actual user to be charged, an associated electric service provider, and an associated electric power service.

15. The method of claim 1, comprising:
transmitting electric outlet identification information and user identification information to an accounting server upon generation of a predetermined event,
wherein the accounting server is configured to:
receive electric charging operation information from the electric vehicle upon generation of a predetermined event;
generate service fee information based on the received electric charging operation information, the received electric outlet identification information and the received user identification information;
calculate a service fee based on the generated service fee information; and
perform an operation for charging the determined actual user for the calculated service fee.

16. A method of authorizing an electric vehicle to perform an electric charging operation by user equipment, the method comprising:
obtaining electric outlet identification information from an electric outlet upon generation of a predetermined event;
obtaining user identification information of at least one of the user equipment and the electric vehicle;
generating an electric charging request message based on the obtained information in order to perform an electric charging operation of the electric vehicle; and
transmitting the generated electric charging request message to an electric charging authorization server.

17. The method of claim 16, comprising:
receiving one of an electric charging approval message and an electric charging disapproval message from the electric charging authorization server in response to the electric charging request message;
controlling the electric vehicle to perform an electric charging operation when the received message is the electric charging approval message; and
controlling the electric vehicle not to perform the electric charging operation when the received message is the electric charging disapproval message.

18. The method of claim 16, wherein the obtaining electric outlet identification information includes:
capturing a code pattern image posted with the electric outlet; and
obtaining the electric outlet identification information by decoding the captured code pattern image.

19. The method of claim 16, wherein:
the electric outlet identification information includes location information of the electric outlet, service provider information, and electric power service information; and
the user identification information includes identification information of at least one of the user equipment and the electric vehicle and location information of at least one of the user equipment and the electric vehicle.

20. A method of authorizing an electric vehicle to perform an electric charging operation by an electric vehicle, the method comprising:
receiving one of an electric charging approval message and an electric charging disapproval message from at least one of an electric charging authorization server and associated user equipment in response to an electric charging request message transmitted from the associated user equipment;
controlling a power unit to perform an electric charging operation in response to the electric charging approval message; and
controlling the power unit not to perform the electric charging operation in response to the electric charging approval message.
